(19) United States
(12) Patent Application Publication
(10) Pub. No.: US 2025/0014032 A1
(43) Pub. Date: Jan. 9, 2025

(54) DELAYED AUDITING FOR DISTRIBUTED LEDGER TRANSACTIONS

(71) Applicant: International Business Machines Corporation, Armonk, NY (US)

(72) Inventors: Angelo De Caro, Zürich (CH); Kaoutar El Khiyaoui, Zurich (CH); Marcus Brandenburger, Zurich (CH); Elli Androulaki, Zürich (CH)

(21) Appl. No.: 18/347,867

(22) Filed: Jul. 6, 2023

(51) Int. Cl. G06Q 20/40; G06Q 20/38

(52) U.S. Cl. CPC G06Q 20/401; G06Q 20/389

(57) ABSTRACT

In an approach, a processor creates a first transfer transaction by a transaction sender for an asset managed by a distributed ledger system to a transaction receiver, where: the first transfer transaction comprises an output and a related delayed auditing script indicative of a legitimate owner of the output; and the first transfer transaction is in a pending status. A processor submits the first transfer transaction by the transaction sender to the distributed ledger system, thereby committing the first transfer transaction by the distributed ledger system such that the pending status is dissolved. A processor creates a second transfer transaction by the transaction receiver based upon the output, wherein for a validity of the second transfer transaction, only a signature from an auditor for the first transfer transaction is presented to the distributed ledger system.

### BACKGROUND

The present invention relates to an approach for a delayed auditing of a transaction in a distributed ledger system, and more specifically, to an approach for a delayed auditing of a transaction in a distributed ledger system using a privacy-preserving unspent transaction output (UTXO) operation model.

The importance of digital currencies has grown steadily over the past decade. More recently, the importance of cash seems to be declining. Several of recent digital disruptions, including the emergence of crypto-currencies and blockchain technologies, have made waves in the financial-services sector.

In financial systems, an auditor is responsible for ensuring that processes are conducted according to their specifications. In particular, the examination and verification of transaction details are crucial to ensure the correct compliance of the company with legal requirements. In a Central Bank Digital Currency (CBDC) setting, digital tokens are tracked in a tamper-resistant way on a distributed ledger, where Central Banks may issue digital cash as tokens. Users of the system can send funds, represented as tokens, to each other. For instance, Alice can send funds to Bob as part of a purchase action.

Prequalifying participants enable funding of the transaction before parties enter into a trade, reducing the time required to consummate a transaction. In one aspect, the credit aspect of these transactions is disaggregated from the transactions themselves, eliminating credit risk and delivery risk, among others. Immutability of data in the blockchain enhances transaction reliability and promotes confidence on both sides of a given transaction.

### SUMMARY

According to an embodiment of the present invention, a computer-implemented method, computer program product, and computer system are provided. A processor creates a first transfer transaction by a transaction sender for an asset managed by a distributed ledger system to a transaction receiver, where: the first transfer transaction comprises an output and a related delayed auditing script indicative of a legitimate owner of the output; and the first transfer transaction is in a pending status. A processor submits the first transfer transaction by the transaction sender to the distributed ledger system, thereby committing the first transfer transaction by the distributed ledger system such that the pending status is dissolved. A processor creates a second transfer transaction by the transaction receiver based upon the output, wherein for a validity of the second transfer transaction, only a signature from an auditor for the first transfer transaction is presented to the distributed ledger system.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject matter, also any combination between features relating to different subject matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments to which the invention is not limited.

Embodiments of the invention will be described, by way of example only, and with reference to the following drawings:

FIG. 1 shows a block diagram of an embodiment of the inventive computer-implemented method for a delayed auditing of a transaction in a distributed ledger system using a privacy-preserving UTXO operation model.

FIG. 2 shows a block diagram of a digital asset transformation using active auditing, in accordance with an embodiment of the present invention.

FIG. 3 shows a block diagram of the general concept of the UXTO model, in accordance with an embodiment of the present invention.

FIG. 4 shows as a block diagram of a transaction validation process in the used UXTO environment and the additional tools required to allow the delayed auditing, in accordance with an embodiment of the present invention.

FIG. 5 shows a block diagram of the newly proposed transaction validation process 500 using a pool of transactions, in accordance with an embodiment of the present invention.

FIG. 6 shows a more implementation-near flowchart of the inventive concept, in accordance with an embodiment of the present invention.

FIG. 7 shows a block diagram of an embodiment of the inventive delayed auditor system for a delayed auditing of a transaction in a distributed ledger system using a privacy preserving UTXO operation model, in accordance with an embodiment of the present invention.

FIG. 8 shows an embodiment of a computing system comprising the system according to FIG. 7.

### DETAILED DESCRIPTION

In the context of this description, the following technical conventions, terms and/or expressions may be used:

The term ‘delayed auditing’ may denote a process of not validating a transaction immediately after a transfer transaction of a token from a transaction sender to a transaction receiver. Hence, the auditing process may be performed asynchronously, i.e., later than the actual transaction. This may solve the problem of the bottleneck of the auditor's validation process.

The term ‘transaction in a distributed ledger system’ may denote a transfer of funds in the form of a token (tokens) from a transaction sender to a transaction receiver.

The term ‘privacy-preserving unspent transaction output (UTXO) operation model’ may denote that the related tokens may be transferred in no way without allowing to identify an owner or receiver of a token transfer, i.e., in the same way just as real money may be transferred to another private preserving way.

The term ‘transfer transaction’ may denote giving access to funds in the form of a token in a distributed ledger system to a new owner, i.e., the transaction receiver. The ‘transaction sender’ may be the originator of the transfer transaction.

The term ‘asset’ may denote any value related to a token, e.g., in the form of the digital currency.

The term ‘output’ may denote a result of a transaction in a distributed ledger system. On the other side, each transaction may also comprise at least one ‘input’.

The term ‘delayed auditing script’ may denote a ciphertext comprising data about a current owner and the previous owner of the token (or tokens) to be transferred from a transaction sender to a transaction receiver. The delayed auditing script may allow an asynchronous auditing process.

The term ‘legitimate owner of the output’ may denote an owner of assets in the form of a digital token before and/or after a transfer transaction.

The term ‘pending status’ may describe a transaction which may not have been confirmed or committed.

The term ‘submitting the first transfer transaction’ may denote an owner of a token initiated a token transfer to a transaction receiver. In contrast to this, a second transfer transaction may be initiated by the transfer transaction receiver in a second step.

The term ‘committing the first transfer transaction’ may denote confirming the validity of the asset transfer finally to the distributed ledger system.

The term ‘identifier of a transaction receiver’ may denote a digital code or identifier allowing to relate digital tokens to a user ID in a distributed digital ledger system. However, privacy may be guaranteed because the identifier or digital code may not allow to make any conclusions about the real person behind the digital code or identifier.

The term ‘ciphertext’ may denote an encrypted text.

The term ‘pool of unspent tokens’ may denote a storage for digital identifiers—e.g., in the form of serial numbers and related amounts—as part of the solution proposed here.

The term ‘indication about a timeout term’ may denote a sort of deadline until which a token of a transfer transaction may have been claimed by the transaction receiver or current owner.

The term ‘distributed ledger system’ (DLT) may denote a digital system for recording transactions of assets in which the transactions and the details are recorded in multiple places, using distributed nodes, at the same time. Unlike traditional central databases, distributed ledgers have no central data store or administration functionality. Instead, a peer-to-peer consistency check may ensure that all nodes may record the same transactions in the same way. Typical implementations use blockchain technology, like Bitcoin, Eutherium or Hyperledger Fabric.

The term ‘asset’ may denote here a monetary value codified as one or more digital tokens.

Embodiments of the present invention recognize that in order to increase trust and stability of blockchain based asset transactions, an active auditing may be required for the transactions, i.e., each transaction has to be validated before it gets committed to the ledger system. Embodiments of the present invention recognize that, in such a scenario, if the transaction is not signed by the auditor, the transaction gets rejected. Furthermore, an active auditor has to keep track of all transactions audited so far in what is denoted as the audit database. However, if the auditor did not, for any reason, confirm the transaction, the transaction finally gets rejected. Accordingly, embodiments of the present invention recognize that, the auditor or the active auditing process represents a real bottleneck in the approach. If the auditor is not fast enough, the usability of the digital cash system may suffer significantly.

Embodiments of the present invention recognize that no known approaches solve the bottleneck problem of an active auditing setup when dealing with digital cash. Embodiments of the present invention describe an approach that may solve this dilemma.

In the following, a detailed description of the figures will be given. All instructions in the figures are schematic. Firstly, a block diagram of an embodiment of the inventive computer-implemented method for a delayed auditing of a transaction in a distributed ledger system using a privacy-preserving UTXO operation model is given. Afterwards, further embodiments, as well as embodiments of the delayed auditor system for a delayed auditing of a transaction in a distributed ledger system using a privacy preserving UTXO operation model, will be described.

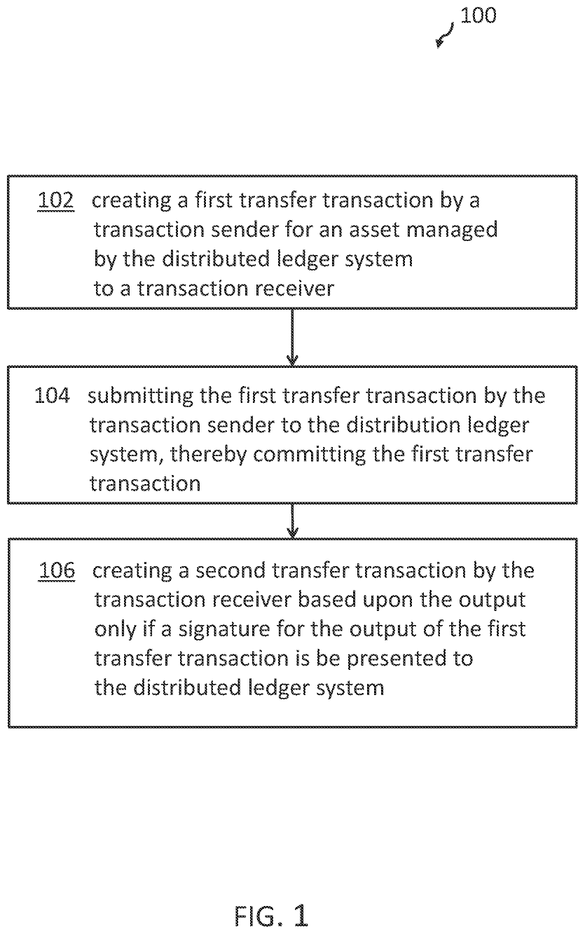

FIG. 1 shows a block diagram of an embodiment of the inventive computer-implemented approach 100 for a delayed auditing of a transaction in a distributed ledger system using a privacy-preserving UTXO operation model. The approach 100 comprises a process creating. 102, a first transfer transaction by a transaction sender for an asset managed by the distributed ledger system—e.g., Bob—to a transaction receiver, where the transfer transaction comprises an output (or more outputs, e.g., typically also a rest) and a related delayed auditing script indicative of a legitimate owner of the output, wherein the transfer transaction is in a pending status.

The approach 100 comprises a process submitting. 104, the first transfer transaction by the transaction sender to the distributed ledger system, thereby committing the first transfer transaction by the distributed ledger system such that the pending status is dissolved, and creating. 106, a second transfer transaction—i.e., after the first transaction got committed—by the transaction receiver based upon the output (i.e., of the first transaction), where for a validity of the second transfer transaction only a signature from an auditor for the first transfer transaction is being presented to the distributed ledger system, and particular by the transaction receiver. This can be (i) an original issue transaction auditor signature or (ii) a delayed signature of the auditor.

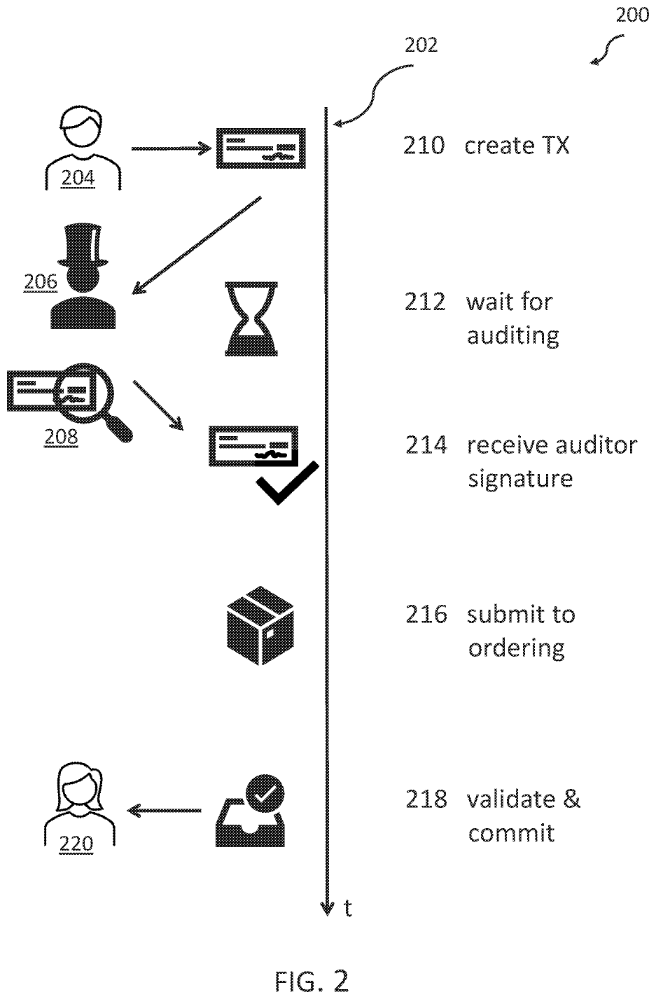

FIG. 2 shows a block diagram of a digital asset transformation 200 using active auditing. In this case, Bob (artificial name) 204 wants to transfer digital assets to Alice (artificial name) 220 in an environment with active auditing. Firstly, Bob creates—or better, their client system—creates, 210, the transaction TX as the initial step of the timeline 202. As a first subsequent step, the auditor 206 has to validate, 208, the signature of Bob and add or receive, 214, the auditor's signature. Hence, along the timeline, this is shown as “wait for auditing, 212”. After the auditor signature was received, Bob 204 can submit, 216 the transaction to the order, where everything is validated and committed, 218, in the ledger system so that Alice 220 eventually receives the funds in form of a crypto-currency amount. As can be seen, the auditing process delays disadvantageously the sequence of steps along the timeline 202. Furthermore—as described already before—additional problems may occur if Bob 204 would never submit the order (i.e., the submitting) and/or the auditor would delete the original transaction TX 210 in his auditor database.

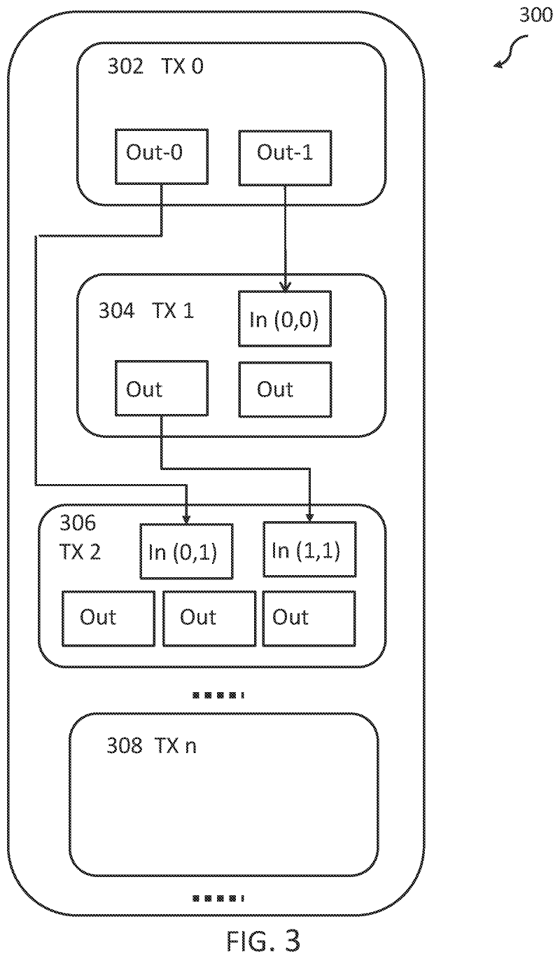

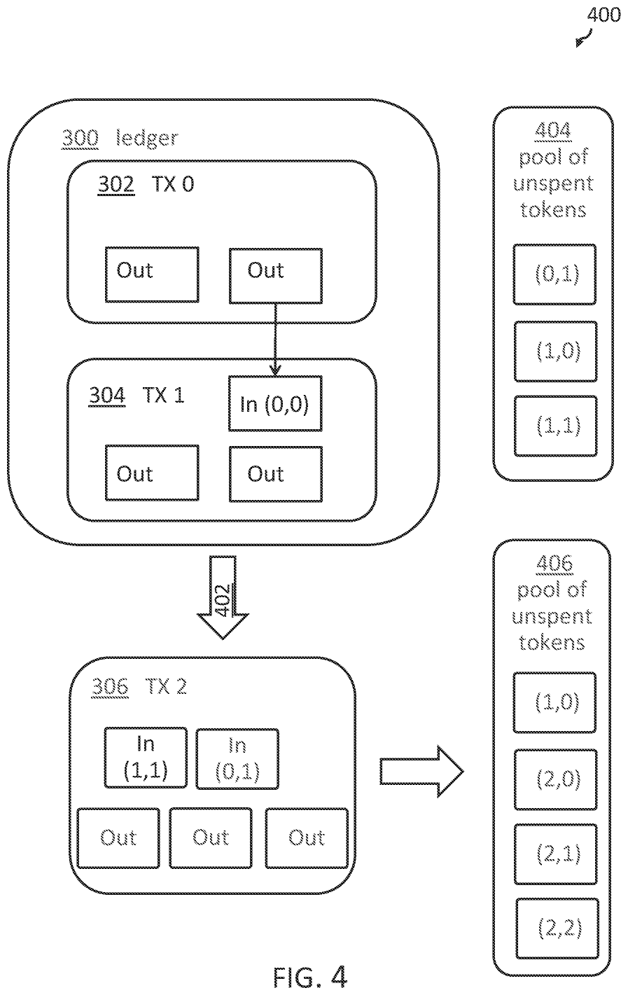

FIG. 3 shows a block diagram of the general concept of the UXTO model and ledger system 300. Also, this diagram shows the technical environment in which the proposed solution needs to work. This is also true for FIG. 4. However, it helps to increase the comprehension of the newly proposed concept.

With the help of FIG. 3, the UTXO model can be explained. All transactions TX 0/302, TX 1/304, TX 2/306, . . . , TX n/308 are finally managed within the ledger system 300. Each transaction comprises a plurality (which can also be “1”) of inputs and outputs, like Out-0, Out-1 of TX 0/302. Outputs can be described in the form of <v, pk>, where v is the value this output comprises, and pk is the public key of the owner, originator or sender of the transaction.

Inputs of transactions are represented in the form of <TXid, oidx>, where TXid is a unique transaction identifier and oidx is the output index. As will be seen in the next figure, all unspent tokens are managed and consolidated in a pool of unspent tokens in a traditional system. Reflecting all of this, one can easily see that transaction TX 2/306 has two inputs—in particular, In (0,1) and In (1,1)—and three outputs, and so on. Therefore, a token transaction removes the inputs from the pool and adds the outputs to the pool. And, an auditor is responsible for verifying the validity of the fund transfers, e.g., transactions are within allowed limits. Users can use received funds only if previous transactions are valid, i.e., validated through an auditor.

FIG. 4 shows, as a block diagram, a transaction validation process 400 in the used UXTO environment, and according to an embodiment of the present invention, mainly the additional tools required to allow the delayed auditing. Here, the underlying ledger system 300 comprises—as an example—only the two transactions TX 0/302 and Tx 1/304. Now, the transaction TX 2/306 is appended, 402. The related validation predicate ensures that the transaction is valid, and the required double-spending check ensures that inputs should still be in the pool of unspent tokens.

In contrast to traditional environments, a pool of tokens 502 before the appending, 402, as well as a pool 504 of serial numbers of input tokens are shown. This applies also the time after the appending, 402, the transaction TX 2. i.e., the pool of output tokens 506 and the pool 508 of serial numbers of input tokens.

As can be seen, the pool 502, 504 does not show any consolidation but a pool of all input tokens (0,0), . . . , (2,2). Hence, nothing is ever removed from the pool 502, 504 of output tokens and the pool of serial (input) token numbers 504, 508.

The pool of tokens 502, 506—after each transaction—should be available on each node of the distributed ledger system and may also be derived by the ledger system. Elements of the pool of unspent tokens are not part of the blockchain of the distributed ledger system. What can also be seen is that after a transaction, inputs are removed from the pool of unspent transactions. This is why the elements In (0,1) and In (1,1) are no longer part of the pool of unspent tokens 406, but In (1,0) remains. As a reminder, up to here, the existing UTXO model has been described in which the newly proposed concept should be integrated.

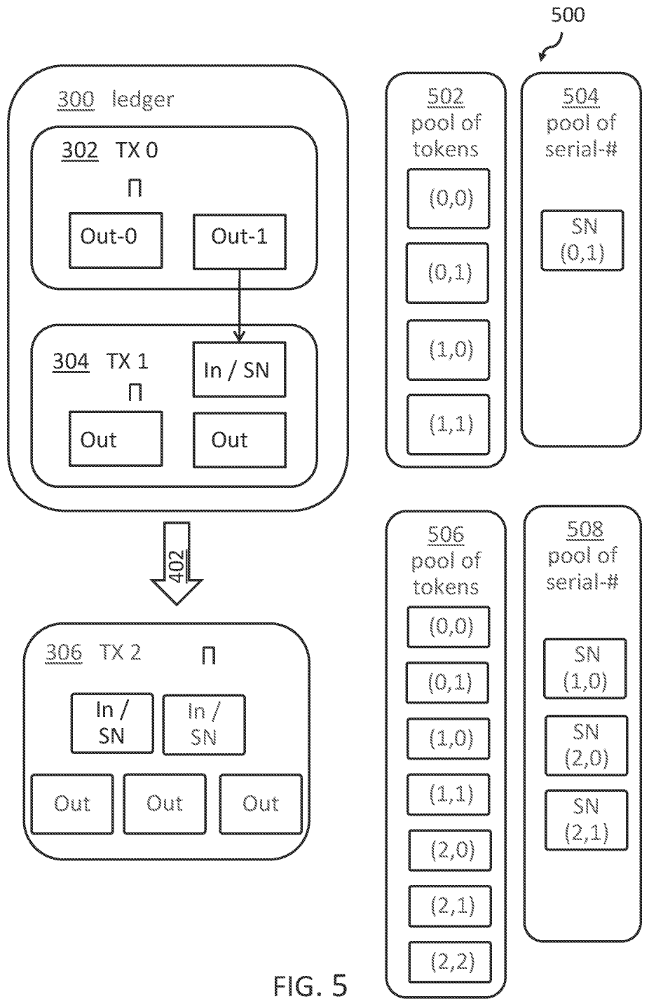

FIG. 5 shows a block diagram of the transaction validation process 500 using a pool of transactions in accordance with an embodiment of the present invention. Basically, the ledger system 300 as well as the appending the transaction TX 2/306, as well as the pool of unspent tokens 404 is identical to what has been explained in the context of FIG. 4. However, the transaction validation requires an additional check, namely the revoked transaction check. For this, the pool of tokens 502 before appending the transaction TX 2 and after the integration of the transaction TX 2 into the ledger system 300 is necessary.

The three required checks are now (i) the validation predicate which ensures that the transaction is valid, (ii) the double-spending check according to which the related input serial number should be not be available in the pool of serial numbers which requires only a simple search, and (iii) the revoked transaction check according to which the transaction should not be in the pool of transactions 502, 504 respectively. In addition to the pool of unspent tokens, also the pool of transactions could be derived from the ledger system 300.

In other words, to overcome the limitations of the active auditing as described above, embodiments of the present invention propose to eliminate the need of active auditing. On a high level, such an embodiment works as follows. The existing system is changed by removing the requirement that a transaction needs the auditor's signature to be considered valid, i.e., a token transaction can be committed immediately to the ledger once submitted by the sender. While this indicates to the transaction receiver that they have received some new funds, the output (tokens) can be spent only if a valid signature from the auditor is presented at the time of spending.

Embodiments of the present invention recognize that the idea described can be achieved in the UTXO context if Bob (i.e., the transfer sender) transfers the tokens to some kind of escrow account (e.g., here, the managed pool of tokens) which only issues these tokens, in the positive case when a validation in form of a valid signature from the auditor is presented. The escrow account is modeled via a script attached to the output and which is evaluated at the time of spending of this output. To achieve this, a specialized script is newly introduced that is denoted “delay auditing script”.

In short, a delay auditing script does the following: (i) the delay auditing script names the current owner (CO) and the previous owner (PO); (ii) CO can spend the token, if CO signs a valid transaction that spends the token and presents the signature of the auditor of the output; and (iii) PO can spend the token, if PO signs a valid transaction that spends the token and presents the signature of the auditor on the output concatenated with a flag “Not Spendable”. Supposed that the transfer does not meet the audit rules, the auditor will signal this to the PO, which in turn can get/claim back the token.

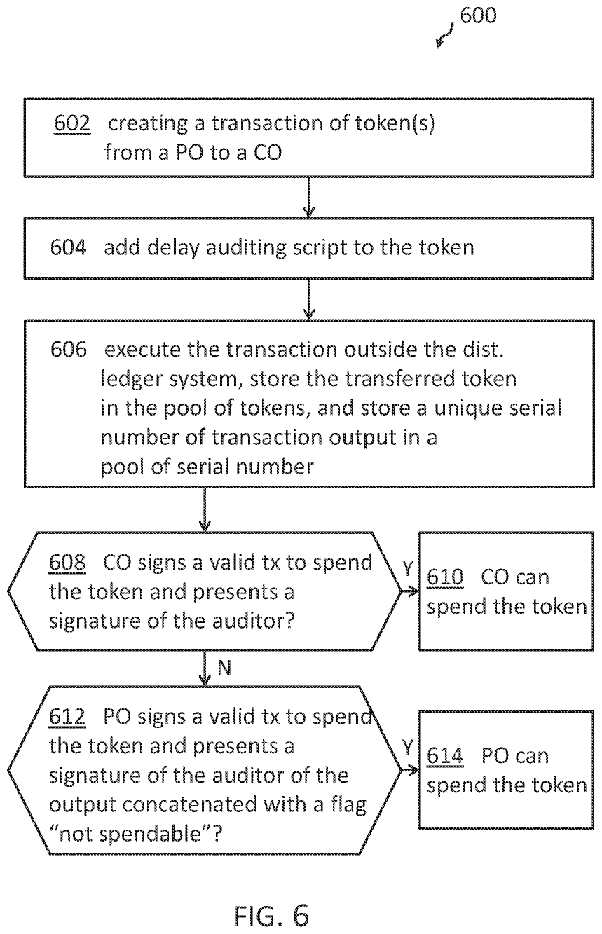

FIG. 6 shows a flowchart 600 of an embodiment of the inventive concept with privacy being a concern. Firstly, a process creates or initiates a transfer transaction of token(s), 602, from the transaction sender—i.e., the previous owner—to a transaction receiver, a current owner of the token(s)/the funds. Thereby, a process adds the delayed auditing script, 604, to the token(s).

Then, a process executes the transaction, 606, outside the distributed ledger system; the transferred token(s) is stored in the pool of tokens, and a unique serial number of the transaction output is stored in a pool of serial numbers.

Now, if the current owner (CO, or transaction receiver) signs a valid transaction to spend the token(s) and if they present the signature of the auditor, a process compares the determination 608 and, in the case of a positive outcome (case “Y”), a process allows the CO to spend the token(s) again, 610. Otherwise (case “N”), a process allows the previous owner—i.e., the transfer transaction sender or initiator—to sign a valid transaction to spend the token(s) and present the signature of the auditor of the output concatenated with the flag “not spendable”, 612. If that is the case (case “Y”), a process allows the previous owner to spend the token(s), 614. I.e., the previous owner has reclaimed the token(s).

In other words, a token transaction comprises serial numbers, commitments, and Zero Knowledge (ZK) Proofs. In such a system, each output is bound to a unique and unlikable serial number. When a transaction spends an output, the transaction reveals the serial number of this output without raveling which output is being spent (this allows the blockchain to check double-spending). The commitments are the digital equivalent of sealed envelopes and comprise the information about the output (type, quantity, etc.). The ZK proofs are used to prove to the blockchain that a valid operation is being performed. Augmenting a transaction with a zero-knowledge proof may prove that encrypted plaintext relating to the ciphertext is compatible with a transfer transaction content, thereby ensuring a privacy-preserving UTXO operation model of the distributed ledger system.

It should be noted that in the traditional setting, the auditor receives the transaction in the clear (i.e., unencrypted) before the transaction gets submitted to the ledger in an obfuscated way, allowing an auditor to perform their job. Given that the auditor is not receiving the transaction in the clear in embodiments of the present invention, this is no longer possible. To overcome such an obstacle, a token transaction is augmented with a ciphertext that contains the transaction's metadata (MT). This ciphertext is encrypted under the auditor's public key. An additional ZK proof guarantees that the content of the ciphertext matches that of the transaction (the commitments).

At this point, the auditor does the following:

The auditor continuously scans the ledger sequentially for outputs not yet audited. When a transaction comprises non-audited outputs, the auditor decrypts the metadata of cyphertext (MCT) and audits the transaction against the MCT. If the auditing succeeds, then the auditor marks the outputs as ‘valid’ in its own local database, otherwise, if the auditing fails, then the auditor marks the outputs as “not valid” in its own local database and notifies the sender. These outputs can be claimed back. At this point, either the auditor publishes the signatures on the ledger or wait for the explicit request from the senders/recipients of the outputs. Both ways are possible.

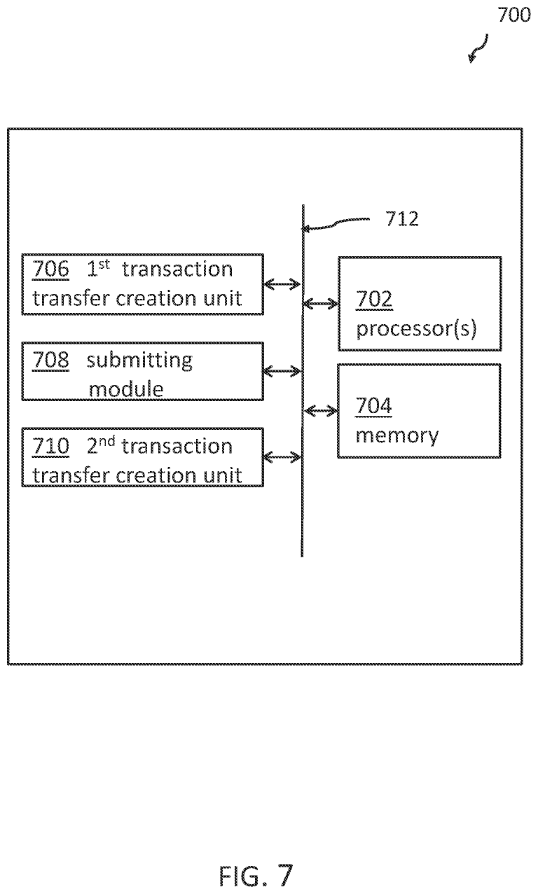

FIG. 7 shows a block diagram of an embodiment of the delayed auditor system 700 for a delayed auditing of a transaction in a distributed ledger system using a privacy preserving UTXO operation model. The system comprises one or more processors 702 and a memory 704 operatively coupled to the one or more processors 702, wherein the memory 704 stores program code portions which, when executed by the one or more processors 602, enable the one or more processors to create—in particular by a first creation unit 706-a first transfer transaction by a transaction sender for an asset managed by the distributed ledger system to a transaction receiver. Thereby, the transfer transaction comprises an output and a related delayed auditing script indicative of a legitimate owner of the output, wherein the transfer transaction is in a pending status.

The one or more processors 702 are also enabled to submit—in particular, by a submitting module 708—the first transfer transaction by the transaction sender to the distributed ledger system, thereby committing the first transfer transaction by the distributed ledger system such that the pending status is dissolved, and to create—e.g. by a second creation unit 710—a second transfer transaction by the transaction receiver based upon the output, wherein for a validity of the second transfer transaction only a signature from an auditor for the first transfer transaction is being presented to the distributed ledger system.

It shall also be mentioned that all functional units, modules and functional blocks—in particular, the first creation unit 706, the submitting module 708 and the second creation unit 710—may be communicatively coupled to each other for signal or message exchange in a selected 1:1 manner. Alternatively, the functional units, modules and functional blocks can be linked to a system internal bus system 712 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

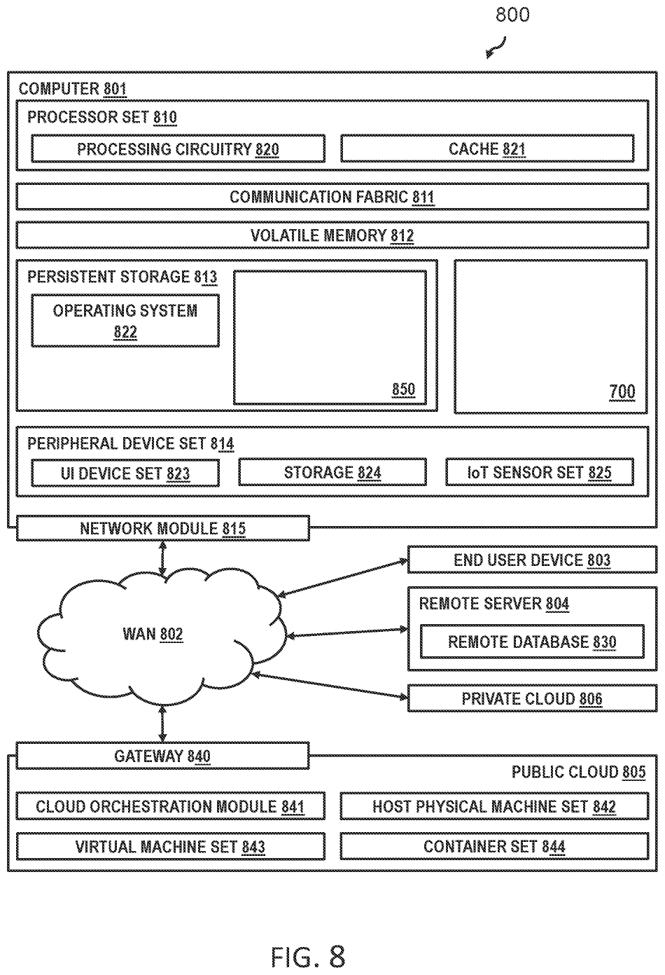

FIG. 8 shows a computing environment 800 comprising an example of an environment for the execution of at least some of the computer code involved in performing the inventive methods, such as the computer-implemented method 100 for a delayed auditing of a transaction in a distributed ledger system using a privacy-preserving UTXO operation model 850.

In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (e.g., embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

It should also be mentioned that the delayed auditor system 700 (compare FIG. 7) for a delayed auditing of a transaction in a distributed ledger system using a privacy-preserving UTXO operation model can be an operational sub-system of the computer 801 and may be attached to a computer-internal bus system.

The terminology used herein is for the purpose of describing particular embodiments only and is not intended to limit the invention. As used herein, the singular forms a, an, and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method comprising:
creating, by one or more processors, a first transfer transaction by a transaction sender for an asset managed by a distributed ledger system to a transaction receiver, wherein:
the first transfer transaction comprises an output and a related delayed auditing script indicative of a legitimate owner of the output; and
the first transfer transaction is in a pending status;
submitting, by one or more processors, the first transfer transaction by the transaction sender to the distributed ledger system, thereby committing the first transfer transaction by the distributed ledger system such that the pending status is dissolved; and
creating, by one or more processors, a second transfer transaction by the transaction receiver based upon the output, wherein for a validity of the second transfer transaction, only a signature from an auditor for the first transfer transaction is presented to the distributed ledger system.

2. The computer-implemented method of claim 1, wherein the delayed auditing script comprises an identifier of a transaction receiver and an identifier of the transaction sender.

3. The computer-implemented method of claim 1, wherein assets received by the transaction receiver can only be transferred again subsequent to the receiver of the asset signing a valid transaction and proving that the signature from the auditor has been added.

4. The computer-implemented method of claim 1, wherein assets relating to the first transfer transaction in the pending status are claimable by the transaction sender subsequent to the transaction sender signing a valid transaction and proving that the signature from the auditor has been added together with a not-spendable flag.

5. The computer-implemented method of claim 1, wherein (i) the delayed auditing script is a ciphertext comprising metadata of the first transfer transaction and (ii) the ciphertext is encrypted by a public key of the auditor, further comprising:
augmenting, by one or more processors, the first transfer transaction with a zero-knowledge proof that proves that encrypted plaintext relating to the ciphertext is compatible with a transfer transaction content, thereby ensuring a privacy-preserving UTXO operation model of the distributed ledger system.

6. The computer-implemented method of claim 1, wherein committing the first transfer transaction also comprises verifying, by one or more processors, a zero-knowledge proof at a transaction verification time of the first transfer transaction in the distributed ledger system.

7. The computer-implemented method of claim 1, further comprising maintaining, by one or more processors, a pool of unspent tokens outside the distributed ledger system.

8. The computer-implemented method of claim 1, wherein a transaction validation in the distributed ledger system comprises:
determining, by one or more processors, that the respective transaction is valid; and
executing, by one or more processors, a double-spending check.

9. The computer-implemented method of claim 1, further comprising generating, by one or more processors, an issue transaction comprising the signature from the auditor.

10. The computer-implemented method of claim 1, wherein the delayed auditing script comprises an indication about a timeout term until which the transaction receiver has to claim a respective transaction as completed.

11. A computer program product comprising:
one or more computer readable storage media, and program instructions collectively stored on the one or more computer readable storage media, the program instructions comprising:
program instructions to create a first transfer transaction by a transaction sender for an asset managed by a distributed ledger system to a transaction receiver, wherein:
the first transfer transaction comprises an output and a related delayed auditing script indicative of a legitimate owner of the output; and
the first transfer transaction is in a pending status;
program instructions to submit the first transfer transaction by the transaction sender to the distributed ledger system, thereby committing the first transfer transaction by the distributed ledger system such that the pending status is dissolved; and
program instructions to create a second transfer transaction by the transaction receiver based upon the output, wherein for a validity of the second transfer transaction, only a signature from an auditor for the first transfer transaction is presented to the distributed ledger system.

12. The computer program product of claim 11, wherein the delayed auditing script comprises an identifier of a transaction receiver and an identifier of the transaction sender.

13. The computer program product of claim 11, wherein assets received by the transaction receiver can only be transferred again subsequent to the receiver of the asset signing a valid transaction and proving that the signature from the auditor has been added.

14. The computer program product of claim 11, wherein assets relating to the first transfer transaction in the pending status are claimable by the transaction sender subsequent to the transaction sender signing a valid transaction and proving that the signature from the auditor has been added together with a not-spendable flag.

15. The computer program product of claim 11, wherein (i) the delayed auditing script is a ciphertext comprising metadata of the first transfer transaction and (ii) the ciphertext is encrypted by a public key of the auditor, further comprising:
program instructions, collectively stored on the one or more computer readable storage media, to augment the first transfer transaction with a zero-knowledge proof that proves that encrypted plaintext relating to the ciphertext is compatible with a transfer transaction content, thereby ensuring a privacy-preserving UTXO operation model of the distributed ledger system.

16. The computer program product of claim 11, wherein program instructions to commit the first transfer transaction also comprise program instructions to verify a zero-knowledge proof at a transaction verification time of the first transfer transaction in the distributed ledger system.

17. The computer program product of claim 11, further comprising program instructions, collectively stored on the one or more computer readable storage media, to maintain a pool of unspent tokens outside the distributed ledger system.

18. The computer program product of claim 11, wherein a transaction validation in the distributed ledger system comprises:
program instructions, collectively stored on the one or more computer readable storage media, to determine that the respective transaction is valid; and
program instructions, collectively stored on the one or more computer readable storage media, to execute a double-spending check.

19. The computer program product of claim 11, further comprising program instructions, collectively stored on the one or more computer readable storage media, to generate an issue transaction comprising the signature from the auditor.

20. A computer system comprising:
one or more computer processors, one or more computer readable storage media, and program instructions collectively stored on the one or more computer readable storage media for execution by at least one of the one or more computer processors, the program instructions comprising:
program instructions to create a first transfer transaction by a transaction sender for an asset managed by a distributed ledger system to a transaction receiver, wherein:
the first transfer transaction comprises an output and a related delayed auditing script indicative of a legitimate owner of the output; and
the first transfer transaction is in a pending status;
program instructions to submit the first transfer transaction by the transaction sender to the distributed ledger system, thereby committing the first transfer transaction by the distributed ledger system such that the pending status is dissolved; and
program instructions to create a second transfer transaction by the transaction receiver based upon the output, wherein for a validity of the second transfer transaction, only a signature from an auditor for the first transfer transaction is presented to the distributed ledger system.
